(19) United States
(12) Patent Application Publication
(10) Pub. No.: US 2017/0230920 A1
(43) Pub. Date: Aug. 10, 2017

(54) DETECTION OF INTERFERENCE IN WIRELESS COMMUNICATION DEVICES

(71) Applicant: QUALCOMM Incorporated, San Diego, CA (US)

(72) Inventor: Amir SHWARTZ, Yahud (IL)

(21) Appl. No.: 15/424,128

(22) Filed: Feb. 3, 2017

Related U.S. Application Data
(60) Provisional application No. 62/291,494, filed on Feb. 4, 2016.

(51) Int. Cl. H04W 52/52; H04L 7/00; H04L 25/03; H04B 17/345

(52) U.S. Cl. CPC H04W 52/52; H04B 17/345; H04L 7/0091; H04L 25/03

(57) ABSTRACT

Certain aspects of the present disclosure relate to methods and apparatus for wireless communication, and more particularly, to methods and apparatus for controlling spurious emissions on devices that support millimeter wave communications. An example method includes providing a local oscillator (LO) signal generated by an LO chain to at least one of a baseband portion or a radio frequency (RF) portion coupled to the baseband portion, detecting interference in the LO signal, and controlling a gain component of the LO chain to adjust an amplitude of the LO signal, based on the detected interference.

### CROSS-REFERENCE TO RELATED APPLICATIONS

This application claims benefit of U.S. Provisional Patent Application Ser. No. 62/291,494, entitled “Spurious Emission Control for Millimeter Wave Wireless Communication Devices,” filed Feb. 4, 2016 and assigned to the assignee hereof, which is herein incorporated by reference in its entirety.

### BACKGROUND

Field

The present disclosure relates generally to wireless communication, and more particularly, to detection of interference in wireless communications devices.

Background

The 60 GHz band is an unlicensed band which features a large amount of bandwidth and a large worldwide overlap. The large bandwidth means that a very high volume of information can be transmitted wirelessly. As a result, multiple applications that require transmission of a large amount of data can be developed to allow wireless communication around the 60 GHz band. Examples for such applications include, but are not limited to, wireless high definition TV (HDTV), wireless docking stations, wireless Gigabit Ethernet, and many others.

In order to facilitate such applications there is a need to develop integrated circuits (ICs), such as amplifiers, mixers, radio frequency (RF) analog circuits, and active antennas that operate in the 60 GHz frequency range. An RF system typically comprises active and passive modules. The active modules (e.g., a phase-array antenna) require control and power signals for their operation, which are not required by passive modules (e.g., filters). The various modules are fabricated and packaged as RFICs that can be assembled on a printed circuit board (PCB). The size of the RFIC package may range from several to a few hundred square millimeters.

In the market of consumer electronics, the design of electronic devices, and thus RF modules integrated therein, should meet the constraints of minimum cost, size, and weight. The design of the RF modules should also take into consideration the current assembly of electronic devices, and particularly handheld devices, such as laptop and tablet computers in order to enable efficient transmission and reception of millimeter wave signals.

### SUMMARY

Certain aspects of the present disclosure provide an apparatus for wireless communications. The apparatus generally includes a radio frequency (RF) portion configured to process RF signals received via one or more antennas to generate intermediate frequency (IF) signals and to process other IF signals to generate other RF signals for transmission via the one or more antennas, a baseband portion configured to process the IF signals received from the RF portion to generate baseband signals and to process other baseband signals to generate the other IF signals for output to the RF portion, a local oscillator (LO) chain configured to generate one or more LO signals for the RF portion or the baseband portion, and one or more detectors configured to detect interference in at least one of the LO signals and to control a gain component of the LO chain to adjust an amplitude of the at least one of the LO signals, based on the detected interference.

Certain aspects of the present disclosure provide a method for wireless communications. The method generally includes providing an LO signal generated by an LO chain to at least one of a baseband portion or an RF portion coupled to the baseband portion, detecting interference in the LO signal, and controlling a gain component of the LO chain to adjust an amplitude of the LO signal, based on the detected interference.

Certain aspects of the present disclosure provide an apparatus for wireless communications. The apparatus generally includes a frequency synthesizer configured to generate an LO signal for a receive or transmit chain that processes intermediate frequency signals, and a detector configured to detect interference in the LO signal and to adjust an amplitude of the LO signal based on the detected interference.

Certain aspects of the present disclosure provide an apparatus for wireless communications. The apparatus generally includes means for generating an LO signal; means for providing the LO signal to a means for processing baseband signals or a means for processing RF signals, the means for processing baseband signals being coupled to the means for processing RF signals; means for detecting interference in the LO signal; and means for adjusting an amplitude of the LO signal based on the detected interference.

### BRIEF DESCRIPTION OF THE DRAWINGS

FIG. 1 illustrates an example laptop computer having radio transmission capabilities.

FIG. 2 illustrates an example radio frequency (RF) system, in accordance with certain aspects of the present disclosure.

FIG. 3 illustrates an example multiplexer, in accordance with certain aspects of the present disclosure.

FIG. 4 is a flow diagram of example operations that may be performed to control spurious emissions in a wireless communications device, in accordance with certain aspects of the present disclosure.

FIG. 5 illustrates an example baseband portion utilizing gain control of the local oscillator to reduce interference in an intermediate frequency (IF) signal, in accordance with certain aspects of the present disclosure.

FIG. 6 illustrates an example RF portion utilizing gain control of the local oscillator to maximize transmission power, in accordance with certain aspects of the present disclosure.

FIG. 7 illustrates an example RF portion that uses a received reference clock signal to generate an RF signal for transmission to another device or generate an IF signal for processing by a baseband module, in accordance with certain aspects of the present disclosure.

### DETAILED DESCRIPTION

Certain aspects of the present disclosure include apparatuses for controlling spurious emissions in a wireless communications device, such as devices employing millimeter wave techniques for communicating at high frequencies (e.g., in the 60 GHz band). In some cases, spurious emissions may be controlled using gain control in a local oscillator (LO) chain at the radio frequency (RF) and baseband modules of a transceiver. In some cases, spurious emissions may be controlled by generating LO signals at the RF and baseband modules of a transceiver using a reference clock common to the RF and baseband modules.

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of radio frequency (RF) communication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using hardware, software, or combinations thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, firmware, routines, subroutines, objects, executables, threads of execution, procedures, functions, etc., whether referred to as software/firmware, middleware, microcode, hardware description language, or otherwise.

Accordingly, in one or more exemplary aspects, the functions described may be implemented in hardware, software, or combinations thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, PCM (phase change memory), flash memory, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

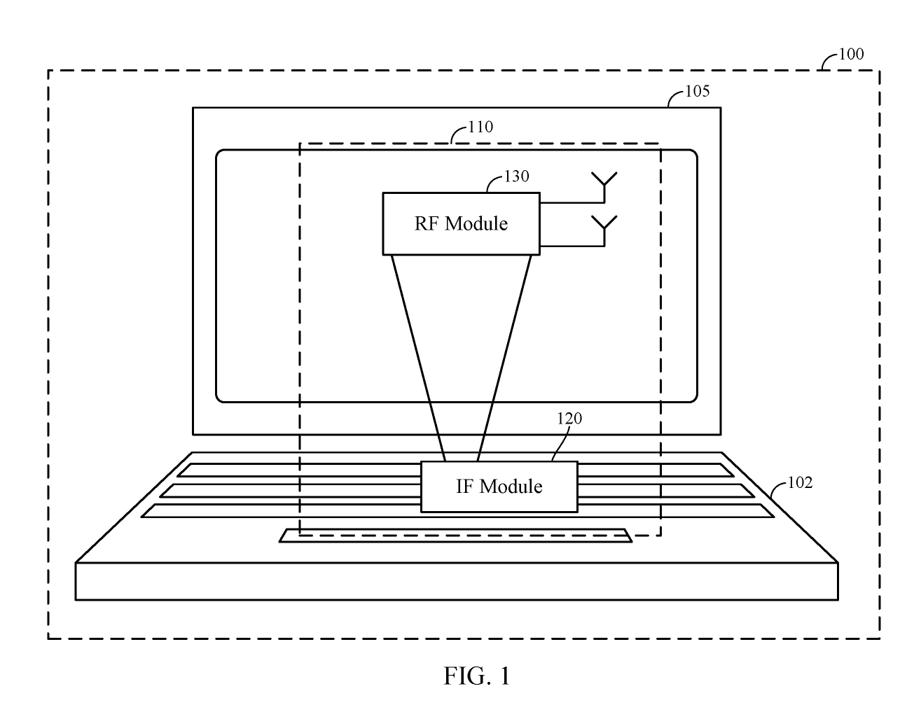

FIG. 1 illustrates an example laptop computer 100 that includes an RF system 110 for transmission and reception of signals, such as millimeter wave (mm-wave) signals (e.g., in the 60 GHz band). The form factor of the RF system 110 is spread between a base plane 102 and a lid plane 105 of the laptop computer 100. The lid plane 105 may be movable with respect to the base plane 102 to open and close the laptop computer 100. As an example, the base plane 102 may include a motherboard and a keyboard for the laptop computer 100, while the lid plane 105 may include a display and one or more antennas.

The RF system 110 includes two parts: a baseband module 120 and RF module 130, which may be located in the base plane 102 and the lid plane 105, respectively. As another example, in a tablet computer, mobile phone, or other device, the baseband module 120 and the RF module 130 may be disposed at any of various suitable locations therein. For example, the baseband module 120 and the RF module 130 may be located at opposite ends of the tablet, phone, or other device. The RF module 130 may include active transmit (TX) and receive (RX) antennas. When transmitting signals, the baseband module 120 may provide the RF module 130 with control, local oscillator (LO), intermediate frequency (IF), and power (DC) signals. The control signal may be utilized for functions, such as gain control, RX/TX switching, power level control, sensors, and detector readouts. Specifically, beam-forming-based RF systems may involve high frequency beam steering operations which are performed under the control of the baseband module 120. The control typically originates at the baseband 120 of the system, and transfers between the baseband module 120 and RF module 130.

The RF module 130 typically performs upconversion, using a mixer (not shown) on IF signals for converting to RF signals and then transmits the RF signals through the TX antenna according to the control of the control signals. The power signals are DC voltage signals that power the various components of the RF module 130.

In the receive direction, the RF module 130 receives RF signals (e.g., at the frequency band of 60 GHz), through the active RX antenna and performs downconversion, using a mixer, to IF signals using the LO signals, and sends the IF signals to the baseband module 120. The operation of the RF module 130 is controlled by the control signal, but certain control information (e.g., a feedback signal) is sent back to the baseband module 120. While this disclosure may describe 60 GHz signals at various locations herein, it will be understood that signals at other frequencies (for example, 28 GHz, 5 GHz, 2.4 GHz, etc.) may be received and/or transmitted by the system 110 according to the principles described herein and/or using components described herein.

Current solutions typically use at least two cables (transmission lines) to transfer the IF, LO, power, and control signals between the baseband and RF modules 120 and 130.

This drawback is critical in millimeter-wave RF systems, e.g., systems that operate in the 60 GHz frequency bands, as the RF module 130 may be constrained to being located close to the active antennas to perform the functions described above in order to minimize the power loss of the received and transmit signals. Thus, the baseband module 120 is located apart from the RF module 130. Further, because transferring high frequency signals over the cables may significantly attenuate the signals, cables that provide low attenuation characteristics are utilized. However, such cables are relativity expensive, thus increasing the bill of material (BoM) of consumer electronics devices.

It would be therefore advantageous to provide a solution for connecting, using a single transmission line, radio frequency modules in an electronic device. One such device may be for communication in the 60 GHz frequency band and/or other millimeter wave bands or other bands outside of the millimeter wave bands.

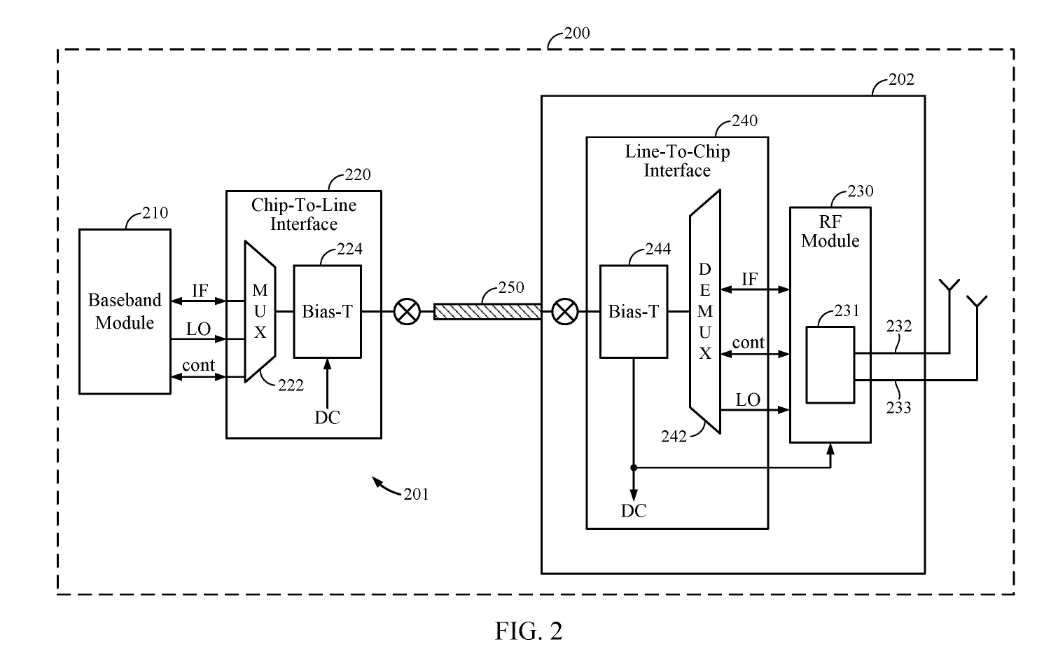

FIG. 2 illustrates an example RF system 200 utilized to describe various aspects of the present disclosure. The RF system 200 includes a baseband module 210 coupled to a chip-to-line interface unit 220. In addition, the RF system 200 includes an RF module 230 coupled to a line-to-chip interface unit 240. The RF module 230 comprises a RF circuitry 231 to perform up- and downconversions of radio signals and to control the TX and RX active antennas 232 and 233. In an aspect of the disclosure, each of the antennas 232 and 233 is a phase array antenna. The RF system 200 enables the efficient transmission and reception of signals in at least the 60 GHz band. In certain aspects, a plurality of RF modules 230 may be tiled or arranged in an array to support a plurality of antennas 232, 233. Each module and/or antenna may operate independently, or tiled and/or arrayed modules and/or antennas may be operated as elements of a single array, for example, to effect beamsteering and/or other transmit or receive functions.

The baseband module 210 and RF module 230 are apart from each other and are connected using a single transmission line 250 through the interface units 220 and 240. In one aspect, the baseband and RF modules 210 and 230 are respectively located at the base and lid planes of a laptop computer. One of ordinary skill should appreciate that a connection between these planes is using, for example, a cable. Placing the baseband and RF modules 210 and 230 apart from each is required to locate the active antennas at such a location where optional reception/transmission of signals may be achieved. Such a location is typically not in proximity to the baseband module which is usually placed by the device's fan/ventilation. As another example, at a tablet computer, the baseband and RF modules 210 and 230 may be located at opposite ends of the tablet, or otherwise near edges of the device in locations that are not proximate.

In certain aspects, at least four different signals are simultaneously transferred over the transmission line 250 including, but not limited to, power, control, intermediate frequency (IF), and local oscillator source (LO). It should be noted that the IF and control signals may be transferred over the line 250 in both directions. In certain aspects, the control signal controls, at least, the switching of the TX and RX active antennas, the direction of the antenna (beamforming), and gain control. The LO signals are required to synchronize the two modules and to perform upconversions and downconversions of high frequency signals.

Each signal transferred over the transmission line 250 may have a different frequency band. In an aspect of the disclosure, a frequency plan is disclosed that enables the efficient transfer of the five signals over the transmission line 250. In accordance with an aspect of the disclosure, the transmission line 250 is a standard micro coaxial cable. In this aspect, the connection between the PCB and the micro coaxial cable uses a micro connector. According to another aspect, the transmission line 250 can be formed by fabricating a metal line on a multilayer substructure.

During the simultaneous transfer of the LO, IF, control, and power signals over the transmission line 250, the interface units 220 and 240 are utilized. The interface units 220 and 240 multiplex the various signals and impedance matches between the transmission line 250 and the PCBs to which the modules 210 and 230 are connected.

As shown in FIG. 2, the chip-to-line interface unit 220 may include a multiplexer 222 and a Bias-T unit 224, and the line-to-chip interface unit 240 may include a demultiplexer 242 and a Bias-T unit 244. The multiplexer 222 multiplexes the IF signal, LO signal, and control signal to be output on a single output provided to the input of the Bias-T unit 224. The Bias-T unit 224 adds a DC voltage signal from a power source and outputs the signal to the transmission line 250. The multiplexer 222 also performs a demultiplexing operation to produce the IF signal(s) and control signal transferred from the RF module 230. In aspects in which a tiling or array of RF modules 230 are implemented, signals for a plurality of modules may be multiplexed onto a single line, or there may be multiple lines between the interface 220 and the interface 240 that each carry an IF, LO, and/or control signal.

The demultiplexer 242 demultiplexes the input received on the transmission line 250, to generate the control signal, IF signal, and LO signal. Prior to that, the Bias-T unit 244 extracts the DC voltage signal to power the RF module 230. The demultiplexer 242 also performs a multiplexing operation on the IF signal (results of a down conversion of the received RF signals) and control signal to be transferred to the baseband module 210.

In the aspect illustrated in FIG. 2, the multiplexer 222 and Bias-T unit 224 are integrated in the baseband module 210 which are embedded in an RFIC. In the same fashion, the demultiplexer 242 and Bias-T unit 244 are integrated in the RF module 230, which is fabricated as an RFIC. In another aspect, the multiplexer 222 and demultiplexer 242 are part of the baseband and RF modules respectively, thus are part of RFICs. The Bias-T units 224 and 244, on the other hand, are part of PCBs 201 and 202; thus the DC signal multiplexing/demultiplexing is performed over the PCBs.

In certain aspects of the disclosure, the source of the LO signal is at the RF module 230. Accordingly, the LO signal is multiplexed with the received IF signal (after down conversion) and transferred to the baseband module 210 over the transmission line 250.

In the aspect shown in FIG. 2, the baseband module 210 and RF module 230 are fabricated on different substrates and connected using a transmission line (e.g., a cable). According to another aspect of the disclosure, the RF and baseband modules are fabricated on the same substrate and are connected using a coaxial cable. In this aspect, the techniques disclosed herein for multiplexing the signals are also applied. In yet other aspects, signals between the RF and baseband modules are conveyed over a signal path without being multiplexed thereon. For example, baseband signals may be conveyed from a baseband chip to a transceiver portion or chip. The transceiver portion or chip may upconvert the baseband signals to IF signals. The IF signals may then be upconverted to RF signals, for example by another portion of the transceiver portion or chip, or by a separate circuit or module. In some such aspects, the RF module may be implemented in a transceiver portion or chip or may instead take the form of an RF portion that is not implemented as a module.

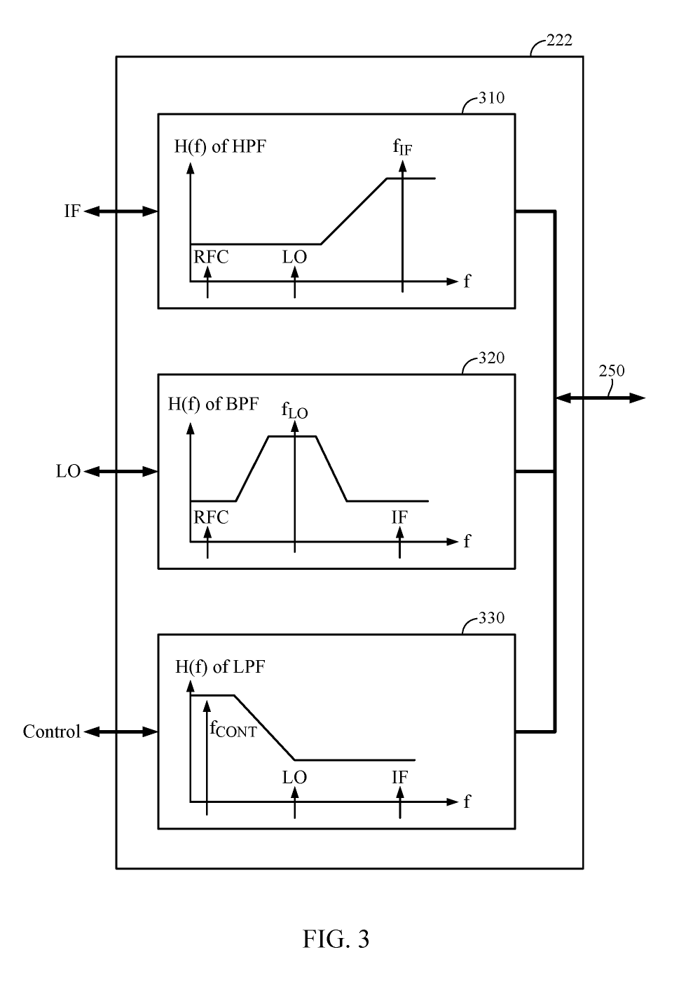

FIG. 3 shows a non-limiting block diagram of the multiplexer 222 constructed in accordance with an aspect of the disclosure. The multiplexer 222 separates the frequency spectrum to three different frequency bands: f_{IF}, f_{LO}, and f_{CTRL} to multiplex the LO signal, IF signal, and control signal in these bands respectively. Specifically, the multiplexer 222 includes a high-pass filter (HPF) 310, a band-pass filter (BPF) 320, and a low-pass filter (LPF) 330; each passes signals in the f_{IF}, f_{LO}, and f_{CTRL} bands, respectively.

While the description above refers to the laptop computer 100 as a reference example of a type of device that may implement the techniques presented herein, those of ordinary skill in the art will recognize that the techniques presented herein may also be implemented in a variety of other types of devices (e.g., such as mobile phones, desktop computer, household devices, etc.). Further, those of ordinary skill in the art will recognize that the form factor of the RF system 110 described above is provided merely as a reference example, and that the techniques presented herein can be applied to other configurations of the RF system 110. For example, in some implementations the RF system 110 may convert from a radio frequency directly to a baseband (and/or vice versa). In some aspects, the various modules described with respect to the RF system 110 are implemented as modules electrically and/or magnetically coupled together in a relatively small form factor (for example, within a mobile telephone or a smart home or Internet of Things (IOT) device) and/or without the use of coaxial cables.

### Example Radio Frequency System with Spurious Emission Control

As described above, some implementations of an RF system in a wireless device may utilize separate RF modules and baseband modules. The RF modules and baseband modules may be connected via one or more transmission lines, e.g., the transmission line 250. For example, a 60 GHz WiFi solution can consist of two separate chips and system in packages (SiPs) for antenna arrays. The RF modules may be located near/with antennas (or antenna arrays), for example, at an optimal radiation point, while the baseband module may be located near an application processor.

In a high frequency transceiver (e.g., a superheterodyne transceiver) including multiple modules (e.g., separate RF modules and baseband modules), the different modules may share a local oscillator (LO). The local oscillator (or periodic signals derived therefrom, which may also be referred to as LO signals) may be driven from one module to another via an interconnect (e.g., via a cable or printed circuit board trace). If the local oscillator is driven at low power, the performance of the transceiver may be degraded. For example, the transceiver may experience an increase in phase noise, a drop in transceiver gain, RF system instability, and sensitivity to RF interference. To avoid degradation of transceiver performance, the local oscillator may be driven at a high power level. Driving the local oscillator at a high power level, however, may generate spurious emissions (e.g., at frequencies that are harmonics of the local oscillator frequency) and may cause the transceiver to exceed regulatory limits on transmission power.

Aspects of the present disclosure provide solutions for generating an LO signal that may avoid the transceiver exceeding limits (e.g., regulatory, operational, and/or other limits) on transmission power and may reduce the generation of spurious emissions from the RF system.

In some cases, the LO signal may be driven with an amplitude (power) that potentially violates the limits and may be stronger than the data signal transferred between a baseband module and an RF module. By using LO signal sensors and gain control on an LO chain in a baseband module and/or an RF module as provided herein, the LO signal may be tuned to a maximum power level that does not violate regulatory limits. In this manner, detectors placed in the baseband module and/or the RF module may provide for tuning a variable gain in the LO chain such that the LO signal provided to a mixer (e.g., for generating an RF signal) is not driven at too low or too high of a power level. As used herein, a “detector” generally refers to a signal sensor and some type of feedback mechanism to control one or more gain components in a signal chain (e.g., the LO chain). The feedback mechanism may include a signal analysis portion to detect interference in the signal sensed by the sensor or to determine and/or affect adjustment of device settings based on interference detected by the sensor, such that the gain component(s) may be controlled based on the detected interference. The detector may include analog circuitry and/or digital circuitry or blocks. For certain aspects, the detector may include a processor or other digital logic located on the baseband module, irrespective of whether a sensor associated with the detector is located on the RF module or the baseband module. In some aspects, the feedback or control mechanism or processor associated with the detector is located within the same portion or module in which the sensor is located.

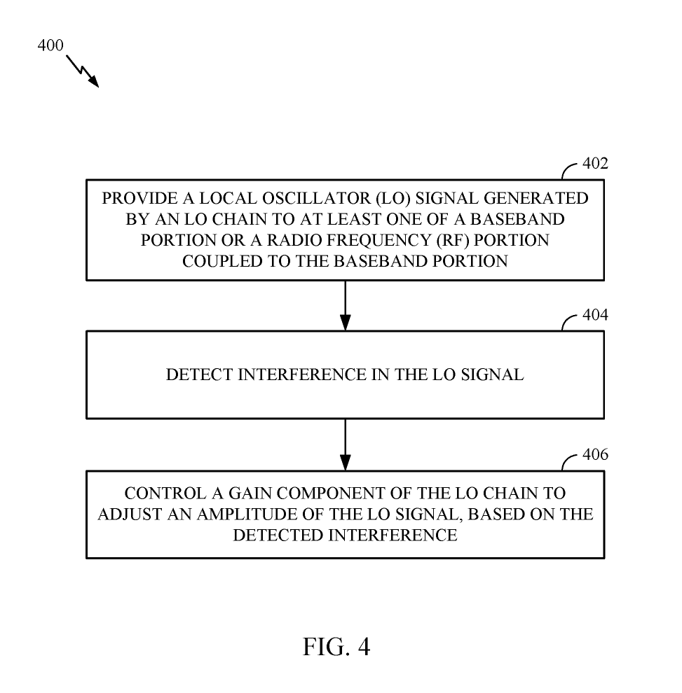

FIG. 4 is a flow diagram of example operations 400 that may be performed in an RF system to control spurious emissions, in accordance with certain aspects of the present disclosure. As illustrated, the operations 400 may begin at block 402, where an LO signal generated by an LO chain is provided to at least one of a baseband portion or an RF portion coupled to the baseband portion. At block 404, interference is detected in the LO signal. At block 406, the RF system controls a gain component of the LO chain (e.g., a frequency synthesizer in the LO chain) to adjust an amplitude of the LO signal based on the detected interference. The baseband portion and/or the RF portion may each be implemented in an individual module, as described above, or may be implemented as a portion of another circuit or chip and/or a larger module.

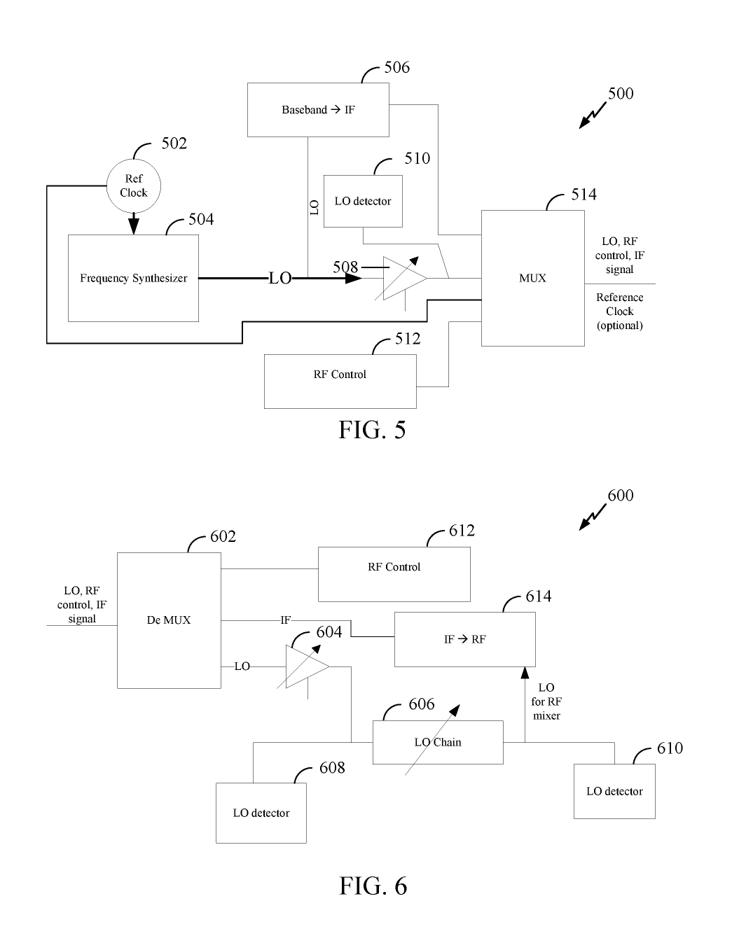

FIG. 5 illustrates an example baseband portion 500 that uses gain control for spurious emission control, in accordance with certain aspects of the present disclosure. As illustrated, the baseband portion 500 generally includes a reference clock 502, a frequency synthesizer 504, a baseband-to-intermediate frequency converter 506 (also referred to as an upconverter), amplifier 508, local oscillator sensor and/or detector 510, RF control signal generator, 512, and multiplexer 514. In some aspects, one or more elements illustrated with respect to baseband portion 500 may be omitted and/or implemented in a module or circuit other than the baseband portion 500. For example, in some aspects one or more of the elements illustrated in FIG. 5 may be implemented within a transceiver or other module or chip. In other aspects, the baseband portion 500 is instead implemented as a transceiver and receives a signal input from a baseband module or chip.

Reference clock 502 generally provides a clock signal to frequency synthesizer 504 for generating a LO signal (e.g., using a phase-locked loop (PLL)). Reference clock 502 may be driven at a low frequency. Because reference clock 502 can generate a reference clock signal at a low frequency, conventional cable shielding may be used in the baseband module to prevent the introduction of noise and/or interference into other signals processed or output by the baseband module (e.g., the IF and RF control signals). The LO signal generated by frequency synthesizer 504 is generally provided to baseband-to-IF converter 506, where a baseband signal is converted to an intermediate frequency signal for further processing by one or more RF modules.

The LO signal generated by frequency synthesizer 504 may additionally be input into an amplifier 508 to be amplified before the amplified LO signal is multiplexed with an IF signal and RF control signaling at multiplexer 514. LO detector 510 monitors the output of amplifier 508 (e.g., the amplified LO signal) to monitor for interference in the amplified LO signal caused by other high frequency signals (e.g., the IF signal). If LO detector 510 detects harmonics and spurs in the RF system (e.g., energy on one or more spurs in the amplified LO signal that exceeds a threshold level), LO detector 510 provides feedback to amplifier 508 to reduce the gain used to amplify the LO signal output from frequency synthesizer 504. If LO detector 510 detects reduced or a lack of interference from other signals (e.g., no spurs exist above the threshold level mentioned previously or above a separate threshold level), LO detector 510 may provide feedback to amplifier 508 to increase the gain used to amplify the LO signal output from frequency synthesizer 504, in an effort to avoid the higher phase noise and increased sensitivity to interferers that occurs with reduced gain. In some cases, LO detector 510 may additionally measure a power level of the LO signal and adjust amplification in the LO chain according to the LO power (e.g., based on zero order interference).

To detect interference from other signals, LO detector 510 can use, for example, root-mean-square (RMS) analysis to analyze an LO signal. The RMS analysis may detect interference in the LO signal or a periodic signal derived from the LO signal (e.g., a signal generated from the LO signal that is further divided, amplified, buffered, phase-shifted, or otherwise processed in a multi-stage LO chain). If, based on the interference analysis, LO detector 510 detects energy on one or more harmonics or spurs relative to the nominal frequency of the LO signal or periodic signal derived therefrom that exceeds a threshold amount, the LO detector can provide feedback to amplifier 508 to reduce the gain used to amplify the LO signal, as described above. In some cases, LO detector 510 can detect interference in the LO signal or a periodic signal derived therefrom by detecting an envelope of the LO signal or periodic signal derived therefrom. The RMS analysis may be performed by analog circuitry, digital circuitry and/or blocks, or a combination thereof.

In some cases, multiplexer 514 may multiplex an IF signal generated by baseband-to-IF converter 506, the amplified LO signal output from amplifier 508, and control signals generated by RF control signal generator 512 for output to one or more RF modules or portions (e.g., RF portion 600, as discussed in further detail below). In some cases, multiplexer 514 may be used to multiplex a reference clock signal from reference clock 502, an IF signal generated by baseband-to-IF converter 506, and control signals generated by RF control signal generator 512 for output to one or more RF modules or portions (e.g., RF portion 700, as discussed in further detail below). In some embodiments, for example in embodiments in which LO, IF, and/or control signals are individually transmitted from a baseband portion to an RF portion or where the baseband and RF portions are implemented within a single chip or module according to some aspects, the multiplexer 514 is omitted.

FIG. 6 illustrates an example RF portion 600, according to one aspect of the present disclosure. RF portion 600 uses gain control based on feedback from one or more sensors to determine an amount of gain to apply to a local oscillator signal to control spurious emissions from the RF portion 600.

As illustrated, RF portion 600 generally includes a demultiplexer 602, amplifier 604, a representative portion of the local oscillator chain 606, local oscillator sensors and/or detectors 608 and 610, RF control processor 612, and IF-to-RF converter 614 (also referred to as an upconverter). Demultiplexer 602 generally receives a multiplexed signal from a baseband module or portion (e.g., baseband portion 500) that includes one or more RF control signals, an IF signal, and a local oscillator signal. RF control signals may be passed from demultiplexer 602 to RF control processor 612, and RF control processor 612 can adjust the parameters defining how RF portion 600 behaves based on the received signaling (e.g., beamforming). In some embodiments, for example in embodiments in which LO, IF, and/or control signals are individually received at an RF portion from a baseband portion or where the baseband and RF portions are implemented within a single chip or module according to some aspects, the demultiplexer 602 is omitted.

The LO signal received from a baseband portion is generally amplified through amplifier 604 and provided to the representative portion of the LO chain 606 to generate another LO signal that can be mixed with the IF signal to generate an RF signal to be transmitted, via one or more antennas (e.g., in an antenna array) to one or more receiving stations. As illustrated, a first LO detector 608 can monitor the output of amplifier 604 for interference on the amplified LO signal generated by amplifier 604, and a second LO detector 610 can monitor the derived LO signal generated by components in the representative portion of the LO chain 606 to examine, for example, interference levels on the derived LO signal. If LO detectors 608 and/or 610 detect interference in the outputs of amplifier 604 and portion of the LO chain 606 (e.g., that exceeds threshold values), respectively, LO detectors 608 and 610 can generate feedback to reduce an amount of gain applied to a signal at amplifier 604 and/or portion of LO chain 606. For example, LO detector 608 can measure a power level of the LO signal and adjust an amount of gain applied by the amplifier 604 and/or portion of LO chain 606 according to the LO power (e.g., based on zero order interference). In some cases, the power level of an RF signal generated from mixing the IF signal with the LO signal may also be monitored and used for amplitude adjustment of the LO signal, in addition to the sensed interference.

In some cases, the number of LO sensors and/or detectors used in an LO chain may be based on the number of times an LO signal is multiplied, divided, amplified, or otherwise processed in the overall LO chain. For example, a portion of an LO chain may receive an LO signal at a frequency of 7.5 GHz and may output a derived LO signal at a frequency of 45 GHz. The portion of the LO chain 606 may first multiply the LO signal by a factor of 3 to generate a 22.5 GHz frequency signal, and then multiply again by a factor of 2 to generate the 45 GHz frequency LO signal used by IF-to-RF converter 614. In such a case, three sensors and/or detectors—in some embodiments, a greater number of sensors than detectors may be used; for example, a single detector may effect device adjustments based on information obtained from a plurality of sensors—may be associated with the portion of the LO chain 606: a first sensor to monitor the received LO signal at 7.5 GHz, a second sensor to monitor the 22.5 GHz frequency signal, and a third sensor to monitor the 45 GHz frequency signal. The output of each sensor may be used to control one or more components (e.g., frequency multipliers) in the LO chain.

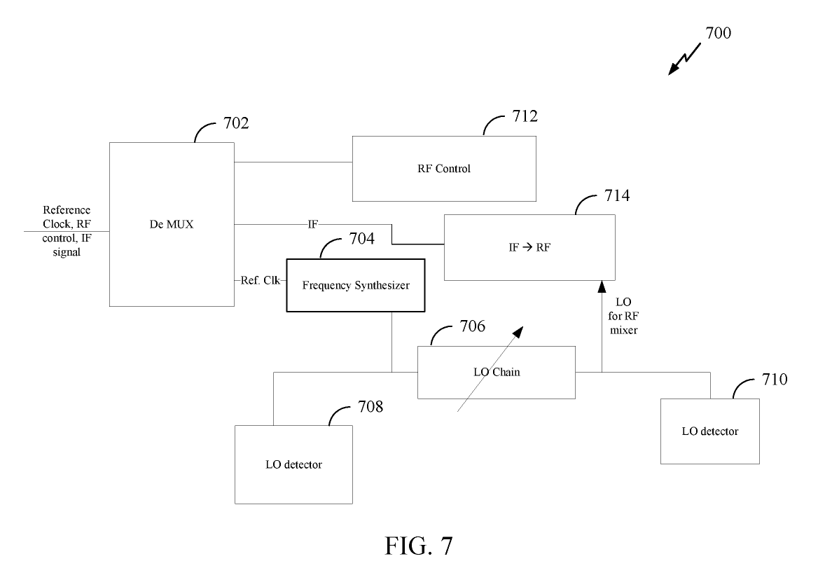

In some cases, as discussed above, an RF portion can receive a reference clock signal instead of an LO signal from a baseband portion 500 and use the reference clock signal to generate one or more LO signals for use on the RF portion (e.g., using a frequency synthesizer in the RF portion). FIG. 7 illustrates an example RF portion 700 that can be used in such a case to generate a first LO signal based on a reference clock signal, according to some aspects of the present disclosure.

As illustrated, RF portion 700 includes a demultiplexer 702, frequency synthesizer 704, LO chain 706, LO sensors and/or detectors 708 and 710, RF control processor 712, and IF-to-RF converter 714. Demultiplexer 702 generally receives a signal from a baseband module or portion (e.g., baseband portion 500) that includes a reference clock signal, an IF signal, and one or more RF control signals. As described above with respect to FIG. 6, demultiplexer 702 demultiplexes (separates) these signals and routes each signal to the appropriate components in RF portion 700 for further processing. That is, RF control signals are routed from demultiplexer 702 to RF control processor 712 for processing, where RF control processor 712 adjusts the parameters defining how RF portion 600 behaves based on the received signaling (e.g., beamforming). IF signals are routed from demultiplexer 702 to IF-to-RF converter 714, where the IF signal is mixed with an LO signal to generate an RF signal that can be output, via one or more antennas, to another device (e.g., an access point or a peer station). In some embodiments, for example in embodiments in which LO, IF, and/or control signals are individually received at an RF portion from a baseband portion or where the baseband and RF portions are implemented within a single chip or module according to some aspects, the demultiplexer 702 is omitted.

Frequency synthesizer 704 generally uses a reference clock signal provided from a baseband portion to generate a first local oscillator signal. The first local oscillator signal may be provided from frequency synthesizer 704 to a representative portion of an LO chain 706 for processing into a second LO signal that can be provided to IF-to-RF converter 714. The LO detectors 708 and 710 generally monitor for interference in the various LO signals. As discussed above, if LO detectors 708 and 710 detect interference in an LO signal above a threshold level, LO detectors 708 and/or 710 can generate feedback to instruct frequency synthesizer 704 and/or portion of LO chain 706 to reduce the gain used in generating this LO signal. Additionally, as discussed above, the power level of the LO signal and/or an RF signal generated from mixing the IF signal with the LO signal may also be monitored.

In some aspects, a baseband signal may be upconverted to an RF signal directly without first being upconverted to an IF signal. In other aspects, elements of the baseband portion 500 and the RF portion 600 and/or 700 are combined into a single chip or module. For example, in some aspects, the synthesizer 504 and other subsequent elements may be combined into an RF module (e.g., comprising the portion 600 and/or 700) or may be implemented with elements of the RF portion 600 and/or 700 in a transceiver chip or module instead of in a baseband chip or module.

In some aspects, the LO sensors and/or detectors described herein may be used to control components in baseband and RF modules other than amplifiers used in generating LO, IF, and/or RF signals. For example, the LO detectors may provide feedback into a mixer component at a baseband module to apply different weightings to an LO and baseband signal for conversion into an IF signal that can be provided to an RF module for further processing. In an RF module, the LO detectors may provide feedback into a mixer component to apply different weightings to an LO and IF signal for conversion into an RF signal for transmission, via one or more antennas, to one or more other devices.

In some cases, to control spurious emissions in a wireless communications device caused by interference introduced into a local oscillator signal, absorbing materials may be used on the local oscillator path (the LO chain). These absorbing materials may include, for example, one or more layers of metallic or polymeric shielding materials connected to an electrical ground, which may be separated from the one or more wires carrying the local oscillator using an insulating material, such as a foamed dielectric. By using absorbing materials on the local oscillator path, energy from the local oscillator signal may be maintained within the local oscillator path. Leaked energy from the local oscillator path may be shunted to a ground using the absorbing materials, which may avoid introducing noise or spurious signals into, for example, control signals, power, and intermediate frequency signals carried between an RF module and a baseband module.

It is understood that the specific order or hierarchy of steps in the processes disclosed above is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

Moreover, the term “or” is intended to mean an inclusive “or” rather than an exclusive “or.” That is, unless specified otherwise or clear from the context, the phrase, for example, “X employs A or B” is intended to mean any of the natural inclusive permutations. That is, for example the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. An apparatus for wireless communications, comprising:
a radio frequency (RF) portion configured to process RF signals received via one or more antennas to generate intermediate frequency (IF) signals and to process other IF signals to generate other RF signals for transmission via the one or more antennas;
a baseband portion configured to process the IF signals received from the RF portion to generate baseband signals and to process other baseband signals to generate the other IF signals for output to the RF portion;
a local oscillator (LO) chain configured to generate one or more LO signals for the RF portion or the baseband portion; and
one or more detectors configured to detect interference in at least one of the LO signals and to control a gain component of the LO chain to adjust an amplitude of the at least one of the LO signals, based on the detected interference.

2. The apparatus of claim 1, wherein the RF portion comprises an RF module, wherein the baseband portion comprises a baseband module, and wherein the RF module and the baseband module are connected via an interconnect configured to carry at least one of the IF signals or the other IF signals.

3. The apparatus of claim 2, wherein:
the baseband module is further configured to provide a first LO signal of the one or more LO signals to the RF module via the interconnect.

4. The apparatus of claim 2, wherein:
the baseband module is further configured to provide a clock signal to the RF module via the interconnect, and
the RF module is configured to use the clock signal to generate a first LO signal of the one or more LO signals.

5. The apparatus of claim 2, wherein the LO chain comprises a frequency synthesizer configured to generate a first LO signal of the one or more LO signals and wherein the frequency synthesizer is located in the baseband module.

6. The apparatus of claim 1, wherein at least one of the detectors is configured to detect the interference by detecting an envelope of the at least one of the LO signals.

7. The apparatus of claim 1, wherein at least one of the detectors is configured to detect the interference based on a root-mean-square (RMS) analysis of the at least one of the LO signals.

8. A method for wireless communications, comprising:
providing a local oscillator (LO) signal generated by an LO chain to at least one of a baseband portion or a radio frequency (RF) portion coupled to the baseband portion;
detecting interference in the LO signal; and
controlling a gain component of the LO chain to adjust an amplitude of the LO signal, based on the detected interference.

9. The method of claim 8, wherein the baseband portion comprises a baseband module, wherein the RF portion comprises an RF module, and wherein the baseband module and the RF module are connected via an interconnect carrying an intermediate frequency (IF) signal.

10. The method of claim 9, further comprising providing a reference clock to the RF module for generating the LO signal.

11. The method of claim 10, wherein the reference clock is carried on the interconnect.

12. The method of claim 9, wherein the providing comprises the baseband module providing the LO signal to the RF module.

13. The method of claim 12, wherein the LO signal is carried on the interconnect.

14. The method of claim 9, further comprising generating the LO signal from a frequency synthesizer located on the baseband module.

15. The method of claim 8, wherein detecting the interference comprises detecting an envelope of the LO signal.

16. The method of claim 8, wherein detecting the interference comprises performing a root-mean-square (RMS) analysis on the LO signal.

17. An apparatus for wireless communications, comprising:
a frequency synthesizer configured to generate a local oscillator (LO) signal for a receive or transmit chain that processes intermediate frequency signals; and
a detector configured to detect interference in the LO signal and to control adjustment of an amplitude of the LO signal based on the detected interference.

18. The apparatus of claim 17, further comprising an amplifier coupled to an output of the frequency synthesizer, wherein the detector is configured to control a gain of the amplifier to adjust the amplitude of the LO signal.

19. The apparatus of claim 17, wherein the detector is configured to control a gain component of the frequency synthesizer to adjust the amplitude of the LO signal.

20. The apparatus of claim 17, further comprising an LO chain coupled to an output of the frequency synthesizer, wherein the detector is configured to control a gain component of the LO chain to adjust the amplitude of the LO signal.

21. An apparatus for wireless communications, comprising:
means for generating a local oscillator (LO) signal;
means for providing the LO signal to a means for processing baseband signals or a means for processing radio frequency (RF) signals, the means for processing baseband signals being coupled to the means for processing RF signals;
means for detecting interference in the LO signal; and
means for adjusting an amplitude of the LO signal based on the detected interference.

22. The apparatus of claim 21, further comprising means for providing a reference clock to the means for processing RF signals, wherein the means for generating is configured to generate the LO signal using the reference clock.

23. The apparatus of claim 22, further comprising means for interconnecting the means for processing baseband signals and the means for processing RF signals, wherein the means for interconnecting is configured to carry the reference clock.

24. The apparatus of claim 21, wherein the means for processing RF signals comprises the means for generating.

25. The apparatus of claim 21, wherein the means for detecting is configured to detect the interference by detecting an envelope of the LO signal.
